(19) United States
(12) Patent Application Publication
(10) Pub. No.: US 2022/0153301 A1
(43) Pub. Date: May 19, 2022

(54) Control Unit and Method for Detecting, Classifying and Predicting an Interaction Requirement of an Automatically Driven Vehicle

(71) Applicant: Bayerische Motoren Werke Aktiengesellschaft, Muenchen (DE)

(72) Inventor: Dominik RIETH, Muenchen (DE)

(21) Appl. No.: 17/433,319

(22) PCT Filed: Mar. 2, 2020
(86) PCT No.: PCT/EP2020/055439

§ 371 Date: Aug. 24, 2021

(30) Foreign Application Priority Data
Apr. 16, 2019 (DE) 10 2019 110 040.2

(51) Int. Cl. B60W 60/00; B60W 50/00

(52) U.S. Cl. CPC B60W 60/0013; B60W 2556/50; B60W 50/0097

(57) ABSTRACT

An electronic control unit for operating an automatically driven vehicle is designed to detect a present driving situation of the vehicle in which an interaction requirement of the vehicle with a server exists. The electronic control unit is further designed to assign an interaction class from a plurality of different interaction classes to the interaction requirement of the present driving situation. An interaction can be carried out with a server with respect to the present driving situation based on the assigned interaction class. The electronic control unit is additionally designed to predict that the automatically driven vehicle can enter a possible driving situation in a future time period in which an interaction requirement of the vehicle with a server exists. One or more measures can then be initiated in order to prevent the possible driving situation and/or in order to change the interaction requirement of the possible driving situation.

### BACKGROUND AND SUMMARY OF THE INVENTION

The present subject matter relates to a method and a corresponding electronic control unit to support an automatically driving vehicle in coping with specific driving situations.

An automatically driving or autonomous vehicle may find itself in driving situations in which safe and reliable autonomous driving is possible and where all subsystems of the automatically driving vehicle function correctly, but which may nevertheless adversely affect the driving of the vehicle. For example, the automatically driving vehicle may be stuck on a currently-used lane behind an obstacle (e.g., a parked removal van) because a traffic rule must be violated to drive past the obstacle (e.g., because of having to cross over a solid line to another lane). Such driving situations could result in the automatically driving vehicle remaining blocked for a long time, whereby the reliability and comfort of the automatically driving vehicle are adversely affected.

The present subject matter deals with the technical task of increasing the reliability and/or comfort of operating an automatically driving vehicle.

The object is achieved by each of the independent claims. Advantageous embodiments are inter alia described in the dependent claims. It should be noted that additional features of a claim which is dependent on an independent claim without the features of the independent claim or only in combination with a subset of the features of the independent claim may form their own invention which is independent of the combination of all the features of the independent claim, and which may be made the subject matter of an independent claim, a divisional application or a subsequent application. This applies in the same way to the technical teachings described in the description, which may form an invention which is independent of the features of the independent claims.

According to an embodiment of the present subject matter, an electronic control unit for the operation of an automatically driving vehicle, such as a motor vehicle, is described. The vehicle may have a level of automation according to SAE Level 3 or higher, preferably according to SAE Level 4 or higher.

The electronic control unit may be configured to detect a present driving situation of the vehicle in which there is a requirement for an interaction of the vehicle with a vehicle-external unit. In other words, a present driving situation with a requirement for an interaction of the vehicle may be detected. The interaction requirement may be an interaction of the vehicle with a human (e.g., a remote operator) at the vehicle-external unit.

The present driving situation may lead to an at least temporary blocking the vehicle so that the vehicle cannot continue its journey. Alternatively, or additionally, the present driving situation may be such that the driving situation may be resolved by a violation of a traffic rule, wherein however the violation cannot be carried out and/or initiated independently by the vehicle. Alternatively, or additionally, the present driving situation may be such that the driving situation does not give rise to an error message from a subsystem of the automatically driving vehicle. On the other hand, the present driving situation may include an accident and/or a technical defect of the automatically driving vehicle.

Furthermore, the electronic control unit may be configured to assign an interaction class from a plurality of different interaction classes to the interaction requirement of the present driving situation. In other words, a classification of the interaction requirement and/or the present driving situation may be carried out. The plurality of different interaction classes may require interaction with at least partially different vehicle-external units. Within the scope of the classification, a vehicle-external unit (e.g., a server, if appropriate with a certain type of human contact person) may be selected from a plurality of different vehicle-external units (e.g., for remote operation of the vehicle, for a service on the vehicle, etc.). Alternatively, or additionally, the plurality of different interaction classes may require sending at least partially different data to a vehicle-external unit. As part of the classification, it is thus possible to determine which data must be exchanged with a vehicle-external unit and/or which data must be sent to the vehicle-external unit (e.g., which sensor data relating to the present driving situation).

In addition, the electronic control unit may be configured, depending on the assigned interaction class, to carry out an interaction relating to the present driving situation with a vehicle-external unit. In particular, the electronic control unit may be configured to carry out the interaction relating to the present driving situation with the (selected) vehicle-external unit for the assigned interaction class and/or to carry out the interaction relating to the present driving situation with the data required for the assigned interaction class. In this way, an actually present driving situation of an automatically driving vehicle may be remedied or resolved in an efficient and reliable manner.

The electronic control unit may also be configured to predict that the automatically driving vehicle could, in a future period, enter a possible driving situation in which there is an interaction requirement for the vehicle with a vehicle-external unit. In other words, it may be predicted in advance, even before a driving situation occurs with an interaction requirement, that the automatically driving vehicle will maneuver itself into a driving situation with an interaction requirement within a certain future period.

In a manner corresponding to the present driving situation, the (predicted) possible driving situation may lead to at least temporary blocking of the vehicle. Alternatively, or additionally, the possible driving situation may be such that the possible driving situation may be resolved by a violation of a traffic rule. Alternatively, or additionally, the possible driving situation may be such that there is no error message from a subsystem of the automatically driving vehicle. On the other hand, the possible driving situation may include an accident and/or a technical defect of the automatically driving vehicle.

The electronic control unit may then be configured, on detecting a future possible driving situation with an interaction requirement, to initiate one or more measures to prevent the possible driving situation and/or to change, in particular to reduce, the interaction requirement in the context of the possible driving situation. The one or more measures may, for example, include: the adaptation of a driving strategy of the automatically driving vehicle; causing a lane change of the automatically driving vehicle; and/or initiating an interaction with a vehicle-external unit before the possible driving situation occurs.

The described electronic control unit allows the comfort and reliability of the operation of an automatically driving vehicle to be increased.

The electronic control unit may be configured to detect the present driving situation based on one or more machine-trained models, preferably based on one or more trained neural networks. Alternatively, or additionally, the electronic control unit may be configured to determine the interaction class based on one or more machine-trained models, preferably based on one or more trained neural networks. Alternatively, or additionally, the electronic control unit may be configured to predict the possible driving situation based on one or more machine-trained models, preferably based on one or more trained neural networks. The machine-trained models may have been trained in advance for the specific task. By using machine-trained models, the measures described in this document may be implemented in a precise and efficient manner.

The electronic control unit may be configured to predict the predicted possible driving situation based on at least one machine-trained predictor with one or more models or neural networks. The predictor may be trained based on data relating to the detected present driving situation and/or based on data relating to the assigned interaction class for the interaction requirement of the present driving situation. The data for training the predictor may include, at least in part, the sensor data detected in the context of the present driving situation. In this way, the reliability and convenience of operating an automatically driving vehicle can be further increased.

The vehicle may use one or more environment sensors (e.g., a camera, a radar sensor, a lidar sensor, etc.), which are configured to determine environment data relating to the immediate environment of the vehicle. The electronic control unit may be configured to detect the present driving situation, to determine the interaction class and/or to predict the possible driving situation based on the environment data.

Alternatively, or additionally, the vehicle may comprise a position sensor which is configured to determine position data relating to a position of the vehicle. The electronic control unit may be configured to detect the present driving situation, to determine the interaction class and/or to determine the possible driving situation based on the position data and on the basis of digital map information relating to the road network in which the vehicle is travelling.

Alternatively, or additionally, the vehicle may comprise one or more vehicle sensors which are configured to determine vehicle data relating to at least one state variable (for example the driving speed) of the vehicle. The electronic control unit may be configured to detect the present driving situation, to determine the interaction class and/or to predict the possible driving situation based on the vehicle data.

In particular, the electronic control unit may be configured to determine characteristic values for a variety of features on the basis of environment data of one or more environment sensors of the vehicle, on the basis of vehicle data from one or more vehicle sensors of the vehicle, on the basis of position data of a position sensor of the vehicle, on the basis of traffic data relating to traffic in the road network in which the vehicle is travelling and/or on the basis of digital map information relating to the road network. Furthermore, the electronic control unit may be configured to detect the present driving situation, to determine the interaction class and/or to predict the possible driving situation based on the characteristic values and using a machine-trained model.

By using sensor data from one or more different sensors of the vehicle, the comfort and reliability of an automatically driving vehicle may be increased in a particularly robust way.

According to a further aspect, a road-going motor vehicle (e.g., a passenger car or a truck or a bus) comprising the electronic control unit is described in accordance with the present subject matter.

According to an embodiment of the present subject matter, a computer-implemented method for the operation of an automatically driving vehicle is described. The method includes the detection of a present driving situation of the vehicle in which there is a requirement for an interaction of the vehicle with a vehicle-external unit. Furthermore, the method includes assigning the interaction requirement of the present driving situation to an interaction class from a plurality of different interaction classes. The method also includes carrying out an interaction relating to the present driving situation with a vehicle-external unit depending on the assigned interaction class. Furthermore, the method includes the prediction that the automatically driving vehicle could enter a possible driving situation in a future period in which there is a requirement for the vehicle to interact with a vehicle-external unit. In addition, the method includes the implementation of one or more measures to prevent the possible driving situation and/or to change, in particular to reduce, the interaction requirement of the possible driving situation.

According to another aspect, a software (SW) program is described. The SW program may be configured to be run on a processor (e.g., on a control device of a vehicle) and thereby to carry out the method described in this document.

According to another aspect, a non-transitory computer-readable memory medium is described. The non-transitory computer-readable memory medium may include a SW program which is configured to execute on a processor, and thereby to perform the method described in this document.

In the context of the document, the term “automatically driving” may be understood as driving with automated longitudinal or lateral guidance or autonomous driving with automated longitudinal and lateral guidance. Driving automatically, for example, may be a longer period of time driving on the motorway or a limited time driving in the context of parking or maneuvering. The term “automatically driving” includes driving automatically with any degree of automation. Example degrees of automation are assisted, semi-automated, highly automated or fully automated driving. These degrees of automation have been defined by the Federal Highway Research Institute (Bundesanstalt für Straßenwesen—BASt) (see BASt publication “Forschung kompakt”, issue November 2012).

During assisted driving, the driver permanently performs longitudinal or lateral guidance, while the system undertakes the respective other function within certain limits. During semi-automated driving (TAF), the system undertakes the longitudinal and lateral guidance for a certain period of time and/or in specific situations, wherein the driver must permanently monitor the system as in assisted driving. During highly automated driving (HAF), the system undertakes the longitudinal and lateral guidance for a certain period of time without the driver having to monitor the system permanently; however, the driver must be able to undertake the vehicle guidance in a certain time. During fully automated driving (VAF), the system may automatically cope with driving in all situations for a specific application; no driver is required for this use case. The four levels of automation mentioned above correspond to SAE levels 1 to 4 of the SAE J3016 standard (SAE—Society of Automotive Engineering). For example, Level 3 of the SAE J3016 standard corresponds to highly automated driving (HAF). Furthermore, SAE J3016 provides for SAE level 5 as the highest degree of automation, which is not included in the definition of BASt. SAE Level 5 corresponds to driverless driving, during which the system can automatically cope with all situations throughout the journey like a human driver; a driver is generally no longer required. The aspects described in this document relate in particular to a vehicle according to SAE Level 3 and higher.

It should be noted that the methods, devices and systems described in this document may be used both alone and in combination with other methods, devices and systems described in this document. Furthermore, all aspects of the methods, devices and systems described in this document may be combined in a variety of ways. In particular, the features of the claims may be combined in a variety of ways.

### BRIEF DESCRIPTION OF THE DRAWINGS

FIG. 1a shows an example driving situation of an automatically driving vehicle;

FIG. 1b shows example components of a vehicle;

FIG. 2a shows an example neural network;

FIG. 2b shows an example neuron; and

FIG. 3 shows a flowchart of an example method for the operation of an automatically driving vehicle.

### DETAILED DESCRIPTION OF THE DRAWINGS

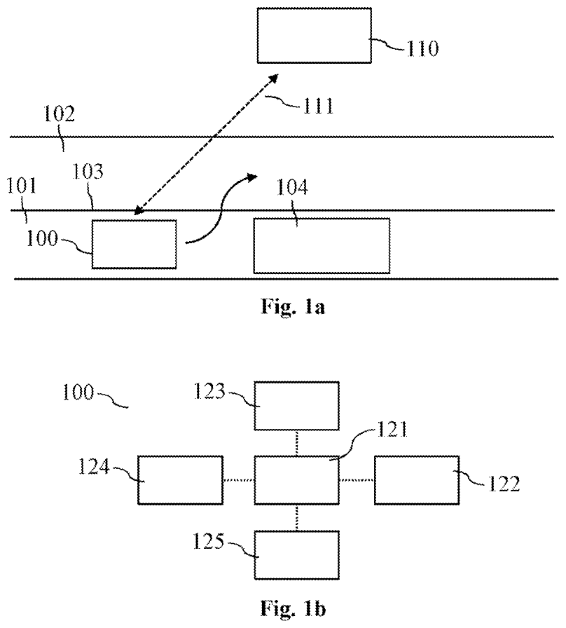

As stated at the outset, this document deals with the technical task of increasing the comfort and/or reliability of an automatically driving vehicle. In this context, FIG. 1a shows an example driving situation of an automatically driving vehicle 100 driving on a first lane 101 of a multi-lane road and obstructed by an obstacle 104 (e.g., by a parked vehicle).

To resolve this situation, the automatically driving vehicle 100 would have to drive onto an adjacent second lane 102 (represented by the curved arrow), which, however, is separated from the first lane 101 by a solid line 103 in the example shown. Since a traffic rule would have to be broken to change lanes, the automatically driving vehicle 100 stops behind the obstacle 104 and is thus blocked.

FIG. 1b shows example components of a vehicle 100. The vehicle 100 comprises one or more environment sensors 122 (e.g., a camera, a radar sensor, a lidar sensor, an ultrasonic sensor, a microphone, etc.), which are configured to detect sensor data (also referred to in this document as environment data) relating to the environment of the vehicle 100. Furthermore, the vehicle 100 comprises a position sensor 123, which is configured to detect position data (e.g., GPS coordinates) relating to the current position of the vehicle 100. The position data may be used in conjunction with digital map information relating to the road network on which the vehicle 100 is travelling to determine the exact position of the vehicle 100 within the road network. Furthermore, the vehicle 100 may comprise one or more vehicle sensors 124 which are configured to determine sensor data (also referred to as vehicle data) relating to a state variable of the vehicle 100. Example state variables are the driving speed of the vehicle, the yaw rate of the vehicle, etc.

The vehicle 100 comprises an electronic control unit 121 which is configured to automatically guide the vehicle 100 longitudinally and/or laterally based on the environment data, the vehicle data, the position data and/or the digital map information. Furthermore, the electronic control unit 121 is configured, based on the above data, to detect a driving situation that involves an interaction with a vehicle-external unit 110 (especially with a human at the vehicle-external unit 110) to resolve the driving situation. The electronic control unit 121 may thus be configured to detect an interaction requirement in a first step.

Furthermore, the electronic control unit 121 may be configured to classify the interaction requirement. For example, a plurality of interaction classes may be defined, wherein the different interaction classes may each be associated with different interaction partners or different external units 110.

The vehicle 100 may comprise a communication unit 125, which is configured to communicate with one or more external units 110 over a wireless communication link 111 (e.g., Wi-Fi, 3G, 4G, 5G, etc.). In particular, the communication unit 125 may be used to send a message to an external unit 110 to the effect that there is an interaction requirement to cope with a current driving situation. The external unit 110 may then exchange data with the vehicle 100 to cope with the driving situation. For example, remote control of the vehicle 100 may be effected by a user using the external unit 110 in order to cope with the current driving situation.

The electronic control unit 121 may also be configured to use data detected in the context of a detected driving situation to train a (machine-trained) predictor to forecast or predict driving situations in the future with a possible interaction requirement. In particular, the machine-trained predictor may make it possible to detect early on that the vehicle 100 is about to maneuver itself into a driving situation that will make an interaction requirement necessary. This information may then be used to adjust the driving strategy of the automatically driving vehicle 100 to prevent the driving situation with the interaction requirement. The reliability of an automatically driving vehicle 100 may be increased in this way.

The detection of a driving situation with an interaction requirement, the classification of the interaction requirement and/or the prediction of a driving situation with an interaction requirement may each be achieved using a trained neural network.

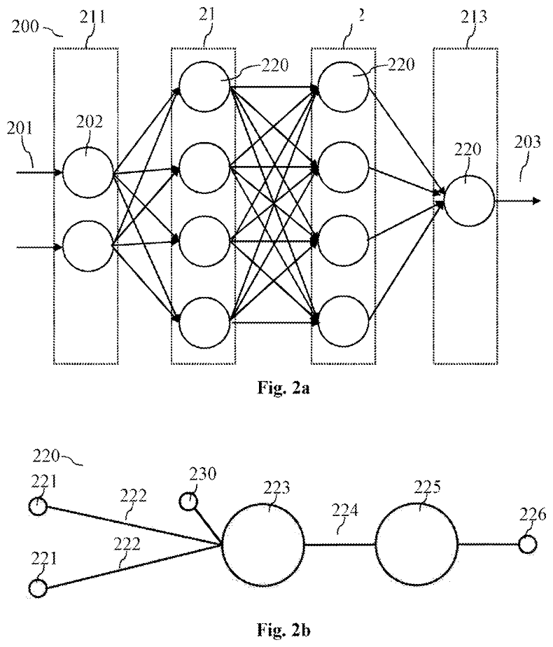

FIG. 2a shows an example neural network 200, in particular a feed forward network. In the example shown, the network 200 comprises two input neurons or input nodes 202, each of which receives at a certain point in time a current value of a measurement variable or a feature as an input value 201. Example input values 201 are the vehicle data, the environment data, the position data and/or the digital map information or data derived therefrom, preferably values of one or more features derived therefrom. The one or more input nodes 202 are part of an input layer 211.

The neural network 200 also comprises neurons 220 in one or more hidden layers 212 of the neural network 200. Each of the neurons 220 has as input values the individual output values of the neurons of the preceding layer 212, 211. In each of the neurons 220, processing is carried out to determine an output value of the neuron 220 depending on the input values. The output values of the neurons 220 of the last hidden layer 212 may be processed in an output neuron or an output node 220 of an output layer 213 to determine an output value 203 of the neural network 200. An example output value 203 of a neural network 200 indicates for example that a driving situation with an interaction requirement exists, which interaction class is present, and/or that the vehicle 100 is in the process of maneuvering itself in a driving situation with an interaction requirement.

FIG. 2b illustrates the example signal processing within a neuron 220, specifically within the neurons 202 of one or more hidden layers 212 and/or the output layer 213. The input values 221 of the neuron 220 are weighted with individual weights 222 to determine a weighted sum 224 of the input values 221 in a summation unit 223 if appropriate, taking into account a bias or offset 230. The weighted sum 224 may be mapped onto an initial value 226 of the neuron 220 by means of an activation function 225. Limiting the range of values may be carried out by means of the activation function 225, for example. For a neuron 220, for example a sigmoid function or a tangential hyperbolic function or a rectified linear unit (ReLU), for example f(x)=max(0, x), may be used as an activation function 225. The activation function 225 may shift the value of the weighted sum 224 with an offset 230 if appropriate.

A neuron 220 thus has weights 222 and/or an offset 230 as neuron parameters. The neuron parameters of neurons 220 of a neural network 200 may be taught in a training phase to cause the neural network 200 to perform a certain function, for example the detection of a driving situation with an interaction requirement, the classification of the interaction requirement, and/or the prediction of an upcoming driving situation with an interaction requirement.

The training of a neural network 200 may be performed for example using the backpropagation algorithm. For this purpose, in a first phase of a q^{th} epoch of a learning algorithm for the input values 201 at the one or more input nodes 202 of the neural network 200, corresponding output values 203 at the output of one or more output neurons 220 may be determined. The input values 201 may be obtained from training data (i.e., from actual vehicle data, environment data, position data and/or digital map information), which also indicate the presence of corresponding target output values (i.e., the presence or absence of a driving situation with an interaction requirement, the interaction class of the interaction requirement and/or the presence or absence of a future driving situation with an interaction requirement). The actual output values determined or predicted by the neural network 200 may be compared with the target output values from the training data to determine the value of an optimization function.

In a second phase of the q^{th} epoch of the learning algorithm, a backpropagation of the error from the output to the input of the neural network takes place in order to change the neuron parameters of the neurons 220 layer by layer. The determined optimization function at the output may be partially derived according to each individual neuron parameter of the neural network 200 in order to determine an extent by which to adjust the individual neuron parameters. This learning algorithm may be repeated iteratively for a number of epochs, until a predefined convergence criterion is reached. At least partially different training data may be used in different epochs.

A system for an automatically driving vehicle 100 is thus described, which answers the questions: 1) Does the vehicle need 100 help, support and/or an interaction with an external unit 110 and/or with a human?; 2) Which form or class of help, support and/or interaction is needed?; and/or 3) How likely is it that the vehicle 100 will need help, support and/or interaction with an external unit 110 and/or with a human within a future time interval?

Thus, in particular, a three-stage system is thus described: 1. Detection of an interaction requirement (for example remote operation of the vehicle 100 or any other (remote) service interaction); 2. Classification of interaction requirement in order to selectively trigger or address an external unit 110 from a plurality of different external units 110 (for example a trigger to a remote operation or to a service or to a towing service or to a public authority); 3. Prediction of an interaction requirement in the future to avoid problems in the future or to resolve likely problems faster.

The detection of an interaction requirement may be mapped by anomaly detection with diverse inputs or input values 201. This has the advantage that the system may be trained without any or with relatively few problem cases (in contrast to other forms of machine learning, which typically require a relatively large amount of training data (also for the case of an error).

The classification of the communication requirement may be provided by another trained model. The trigger of a detected driving situation with an interaction requirement may be used as an input value 201. Furthermore, input values 201 from the model may be used to detect a driving situation with an interaction requirement for the model to classify the communication requirement.

As part of a model for predicting a driving situation with an interaction requirement, higher-level data from the model may be used to detect a driving situation with an interaction requirement and/or from the model to classify the interaction requirement.

The above three stages or steps may be implemented as a cascade of (machine learning) models. Each sub model deals explicitly with a specific task. The output 203 of a sub model may be the input value 201 (or feature) of another sub model. Example input values 201 for a model for the detection of a driving situation with an interaction requirement are:
image data of a camera of the vehicle 100;
an object classification of one or more objects 104 in the environment of the vehicle 100;
the time for which the vehicle 100 is at a standstill;
the number of times that the vehicle 100 has already been overtaken;
a detection of horn signals;
increased attention from passers-by;
the detection of gestures of an occupant of the vehicle 100;
the occupant condition of an occupant of the vehicle 100 (for example nervousness); this information may be detected by an interior sensor (for example an interior camera) of the vehicle 100;
the place and/or time of day;
the history which led to the current driving situation; and/or
the condition of the vehicle 100.

The individual input values 201 and/or features may be modeled with probability density functions, for example in a multidimensional probability density function for multiple features and/or as individual probability density functions for individual features. Based on this, an anomaly detection may then be carried out in order to detect as an initial trigger a driving situation in which a requirement for an interaction with a human exists.

To classify the interaction requirement, the image data of a camera of the vehicle 100 and the fact that a driving situation with an interaction requirement has been detected may be used as input values 201. Then for example a type or a class of driving situation may then be detected (e.g., an accident of the vehicle 100, a parked removal van, a person and/or an animal on the road, etc.). Communication may then be initiated with the identified external unit 110. Targeted information regulating to the present driving situation may be sent to the external unit 110.

The predictor for the prediction of a driving situation with an interaction requirement which has not yet occurred may be operated in parallel with the above steps. A detected driving situation with an interaction requirement and/or the interaction class of the detected driving situation may be used to further train the predictor. A predicted driving situation with an interaction requirement may be used to adjust the driving strategy of the vehicle 100 to prevent the predicted driving situation from actually occurring.

By combining the different stages or steps the reliability of an automatically driving vehicle 100 may be increased to a particularly high degree. The individual machine-trained models (in particular the neural networks 200) may be carried out locally on the vehicle 100 and/or on a backend server.

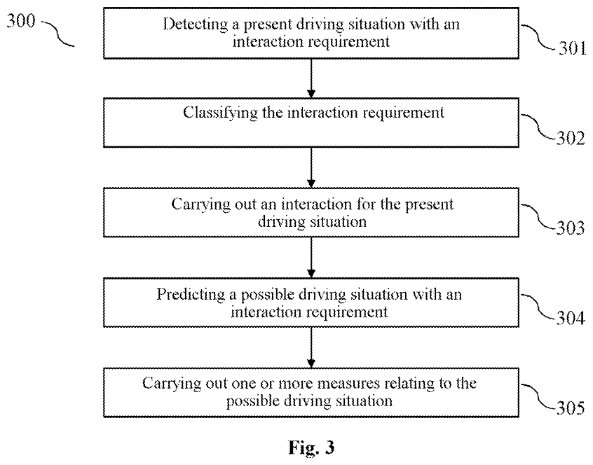

FIG. 3 shows a flow diagram of an example method 300 for the operation of an automatically driving vehicle 100. The method 300 may be carried out by an electronic control unit 121 of the vehicle 100. The method 300 includes the detection 301 of an present driving situation of the vehicle 100, in which there is a requirement for an interaction of the vehicle 100 with a human agent at a vehicle-external unit 110.

In addition, the method 300 includes the assignment 302 of the interaction requirement of the present driving situation to an interaction class from a plurality of different interaction classes. In particular, the vehicle-external unit 110 from a plurality of different vehicle-external units 110 with which there is an interaction requirement may be determined. Alternatively, or additionally, the data to be transmitted as part of the interaction may be determined.

The method 300 also includes performing 303 an interaction relating to the present driving situation with a vehicle-external unit 110 depending on the assigned interaction class. In particular, the interaction may take place with the vehicle-external unit 110 relevant to the assigned interaction class and/or with the data relevant to the assigned interaction class. During the interaction, it may be caused that the driving situation, which leads for example to blocking and/or to a standstill of the vehicle 100, is resolved so that the vehicle 100 may drive on.

Furthermore, the method 300 includes the prediction 304 that the automatically driving vehicle 100 could enter a possible driving situation in a future period in which there is a requirement for an interaction of the vehicle 100 with a vehicle-external unit 110. It may thus be checked in advance whether the vehicle 100 could enter a possible driving situation with an interaction requirement. For this purpose, a machine-trained predictor may be used, which may be or may have been trained based on the data of one or more present driving situations with an interaction requirement.

The method 300 further includes the performance 305 of one or more measures to prevent the possible driving situation and/or to change the interaction requirement of the possible driving situation, specifically to reduce it by the time required for the interaction requirement. For example, the driving strategy of the vehicle 100 may be adjusted at an early stage, and/or an interaction with a vehicle-external unit 110 may be initiated even before the possible driving situation occurs.

All in all, the reliability and comfort of an automatically driving vehicle 100 may thus be increased in relation to driving situations with an interaction requirement.

The present subject matter is not limited to the example embodiments shown. In particular, it should be noted that the description and the figures are intended only to illustrate the principle of the proposed methods, devices and systems.

1.-12. (canceled)

13. An electronic control unit for the operation of an automatically driving vehicle comprising:
a processor;
a memory in communication with the processor, the memory storing a plurality of instructions executable by the processor to cause the electronic control unit to:
detect a present driving situation of the vehicle in which there is a requirement for an interaction of the vehicle with a server;
assign an interaction class from a plurality of different interaction classes to the interaction requirement of the present driving situation;
depending on the assigned interaction class, carry out an interaction with the server relating to the present driving situation;
predict that the automatically driving vehicle could enter a possible driving situation in a future period in which there is a requirement for an interaction of the vehicle with the server; and
to take one or more measures to prevent the possible driving situation and/or to reduce the interaction requirement of the possible driving situation.

14. The electronic control unit according to claim 13, wherein the memory further comprises instructions executable by the processor to cause the electronic control unit to:
detect the present driving situation based on one or more trained neural networks; and/or
determine the interaction class based on the one or more trained neural networks; and/or
predict the possible driving situation based on the one or more trained neural networks.

15. The electronic control unit according to claim 13, wherein the memory further comprises instructions executable by the processor to cause the electronic control unit to:
predict the possible driving situation based on at least one machine-trained predictor; and
train the predictor based on data relating to the present driving situation and/or relating to the assigned interaction class for the interaction requirement of the present driving situation.

16. The electronic control unit according to claim 13, wherein
the interaction requirement includes an interaction with a user at a server.

17. The electronic control unit according to claim 13, wherein
the present driving situation and/or the possible driving situation:
lead to at least temporary blocking of the vehicle;
can be resolved by a breach of a traffic rule;
do not cause an error message from a subsystem of the automatically driving vehicle; and/or
include an accident and/or a technical defect of the automatically driving vehicle.

18. The electronic control unit according to claim 13, wherein the one or more measures include:
adapting a driving strategy of the automatically driving vehicle;
causing a lane change of the automatically driving vehicle; and/or
initiating an interaction with the server before the occurrence of the possible driving situation.

19. The electronic control unit according to claim 13, wherein
the plurality of different interaction classes require an interaction with at least partially different servers; and/or
the plurality of different interaction classes require the sending of at least partially different data to the server; and
the electronic control unit is further configured to carry out the interaction relating to the present driving situation with the server for the assigned interaction class and/or with the data required for the assigned interaction class.

20. The electronic control unit according to claim 13, wherein the memory further comprises instructions executable by the processor to cause the electronic control unit to:
determine characteristic values for a wide range of features based on:
environment data from one or more environment sensors of the vehicle,
vehicle data from one or more vehicle sensors of the vehicle,
position data of a position sensor of the vehicle,
traffic data relating to traffic in a road network in which the vehicle is traveling, and/or
digital map information relating to the road network; and
use a machine-trained model to:
detect the present driving situation,
determine the interaction class, and/or
predict the possible driving situation.

21. The electronic control unit according to claim 13, wherein
the vehicle comprises one or more environment sensors equipped to determine environment data relating to an environment of the vehicle, and
the memory further comprises instructions executable by the processor to cause the electronic control unit to:
detect the present driving situation,
determine the interaction class, and/or
predict the possible driving situation based on the environment data.

22. The electronic control unit according to claim 13, wherein
the vehicle comprises a position sensor set up to determine position data relating to a position of the vehicle; and
the memory further comprises instructions executable by the processor to cause the electronic control unit to:
detect the present driving situation,
determine the interaction class, and/or
predict the possible driving situation based on the position data and based on digital map information relating to a road network in which the vehicle is travelling.

23. The electronic control unit according to claim 13, wherein
the vehicle comprises one or more vehicle sensors set up to determine vehicle data relating to at least one state variable of the vehicle; and
the memory further comprises instructions executable by the processor to cause the electronic control unit to:
detect the present driving situation,
determine the interaction class, and/or
predict the possible driving situation based on the vehicle data.

24. A method for operating an automatically driving vehicle comprising:
detecting a present driving situation of the vehicle in which there is a requirement for an interaction of the vehicle with a server;
assigning the interaction requirement of the present driving situation to an interaction class from a plurality of different interaction classes;
carrying out an interaction relating to the present driving situation with a server depending on the assigned interaction class;
predicting that the automatically driving vehicle could enter a possible driving situation in a future period in which there is a requirement for an interaction of the vehicle with the server; and
carrying out one or more measures to prevent the possible driving situation and/or to reduce the interaction requirement of the possible driving situation.
